(19) United States
(12) Patent Application Publication
(10) Pub. No.: US 2003/0172263 A1
(43) Pub. Date: Sep. 11, 2003

(54) Passive adapter for portable memory cards

(76) Inventor: Wen-Tsung Liu, Taipei Hsien (TW)

Correspondence Address: SUPREME PATENT SERVICES, POST OFFICE BOX 2339, SARATOGA, CA, 95070, US

(21) Appl. No.: 10/093,218

(22) Filed: Mar. 7, 2002

(51) Int. Cl. H04L 9/00

(52) U.S. Cl. 713/156

(57) ABSTRACT

A passive adapter for portable memory cards has a bridge unit, which is inserted in a corresponding PCMCIA card interface. The bridge unit employs a first controller to detect the PCMCIA card interface, which is made in form of a module comprising a slot and a second controller. The slot allows different memory cards to plug on one-at-a-time basis for the controller to detect the category of an inserted memory card. This invention is characterized in: removing the second controller of the module and adding the functions of the second controller to the first controller of the bridge unit and using an added detection-signal conversion controller of the module for detection of the memory cards.

### FIELD OF THE INVENTION

This invention relates generally to a passive adapter for portable memory cards, more particularly, it relates to a passive adapter made according to PCMCIA (personal computer memory card international association) standards for portable memory cards so as to reduce cost and raise additive value of the PCMCIA products.

### BACKGROUND OF THE INVENTION

With Regard to the storage media, today's portable memory cards or flash memory cards are more advantageous in many aspects than the conventional floppy disks or the compact disks. Therefore, we can find various memory cards available in market, such as the Smart card, PC card (PCMCIA ATA Flash card), CF card (Compact Flash card), SM card (Smart Media card), MMC card (Multi-Media card), MS card (Memory Stick card), SD card (Secure Digital card), etc.

However, among abovesaid memory cards, those of the most early erected PCMCIA standards (in 1989) are still considered the mainstream products so far, and almost every notebook PC is provided with at least a PCMCIA slot or more. In response to the existing wide market of the PCMCIA interface slot, many makers have been engaged already in design and research of the adapter capable of accommodating multiple memory cards according to the PCMCIA interface specifications, or of some other adapter cards with specific functions, such as network connecting or phone calling, which are still outnumbered by the PCMCIA interface after all, namely, it is the time to take a PC card adapter to serve for a plurality of small-size memory cards.

FIGS. 1 and 2 show a conventional PC card adapter and a block diagram of control flowchart of a PC card and a small-size memory card respectively, in which FIG. 1 might be considered an assembling flowchart of FIG. 2. A conventional PC card adapter 30 is provided with a second controller 40 (also a media card interface controller) for judging a plugged small-size memory card 50, and is then coupled with a host machine 10 via a bridge unit 20 (to convert a PCMCIA interface into a PCI interface for example), in which the bridge unit 20 employs its embedded first controller (a PC card interface controller) 22 for control of the bridge function.

Therefore, a single PCMCIA interface memory card (a memory card also named PC ATA card) or a PCMCIA interface supported memory card adapter is expanded to become an adapter for support of various memory cards. Such an arrangement can indeed help people cast their confusion in selection of a proper memory card, however, the cost of the adapter is raised because of the extra bridge control chip between the PCMCIA interface and the memory card. If there is any alternative that doesn't require such a bridge control chip for reducing cost?

Thanks to the PCMCIA who has disclosed a new PC card standards (the PCMCIA card) of a fourth generation PCMCIA memory card (also named CardBay standards) later on, in which electrical ratings, data paths, communication protocol, etc., of various memory cards are all regulated (the CardBay standards would be described later in more details). The CardBay standards are emphasized in transplantation with the functions of the bridge control chip to a host chip such that the adapter will no longer need to hold that chip to make cost reduction possible. Nevertheless, however, according to the CardBay standards, only a type of memory card can be detected at a time, namely, a CardBay passive adapter according to the CradBay standards is designed to detect the conversion function of a single memory card. Thus, a different memory card requires another CardBay passive adapter that would probably annoy the users.

### SUMMARY OF THE INVENTION

In view of the above described, the primary object of this invention is to provide a passive adapter for portable memory cards which is an integrated multiple-in-one memory card module based on CardBay standards, in which the bridge control chip in a conventional adapter has been removed and transplanted to a host chip or embedded in another bridge control chip such that it is possible to plug and play any memory card in the passive adapter of this invention and thereby to significantly reduce cost and raise additive value of the adapter module.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 shows a block diagram of control flowchart of a conventional PC card adapter;

FIG. 2 shows a block diagram of control flowchart of a conventional PC card and a small-size memory card;

FIG. 3 shows a system configuration of a passive adapter for multiple-in-one memory card according to this invention;

FIG. 4 shows a block diagram of control flowchart of a portable memory card according to this invention;

FIG. 5 shows an interface circuit of this invention in connection with a PC card;

FIG. 6 shows a circuit for conversion of a small-size memory card of this invention into a PC card; and

FIG. 7 shows a block diagram for judging category of a memory card according to this invention.

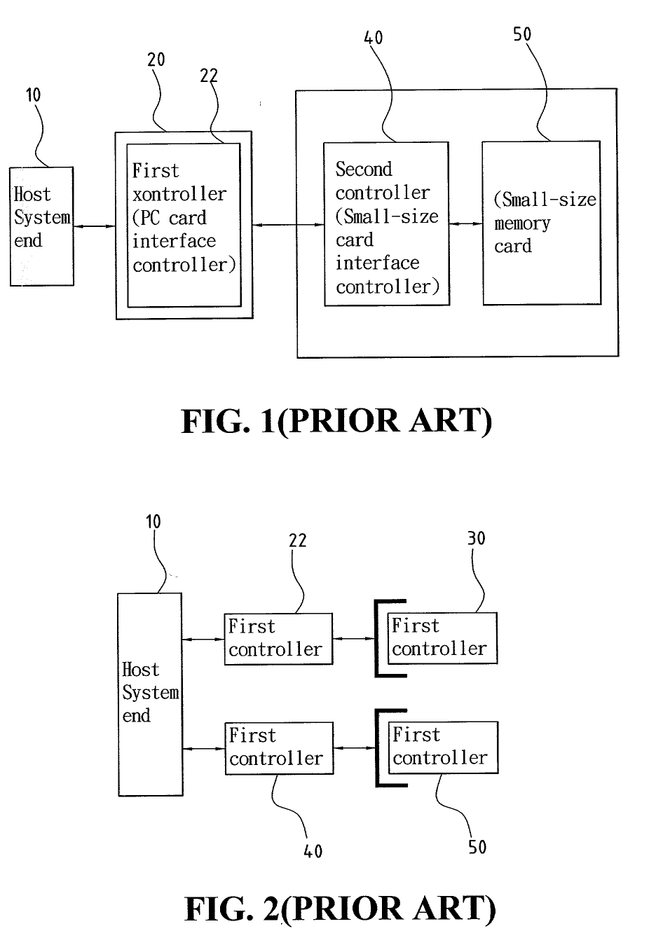

### DETAILED DESCRIPTION OF THE INVENTION

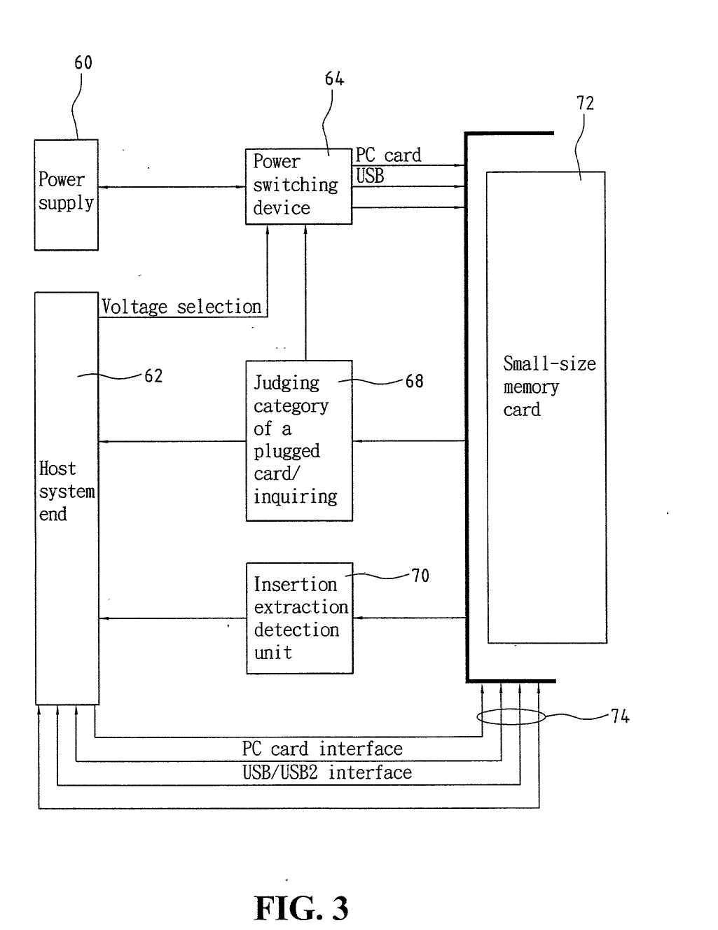

FIG. 3 shows a system configuration of a passive adapter for a multiple-in-one memory card according to this invention. The interface of CardBay standards declared by PCMCIA is capable of directly detecting (judging category of a plugged card/inquiring 68) insertion or extraction of a memory card from a host system end 62 on the one hand, and inquiring (insertion/extraction detection unit 70) if a memory card is inserted to make sure the characteristics thereof on the other in addition to the inherent functions of the PCMCIA card. One point to be emphasized here is that the CardBay standards would request to detect not only a PC ATA card (PCMCIA ATA memory card) from the host system end 62, but also an adapter in form of a PC interface for use of a small-size memory card 72. Moreover, a power supply 60 by side of the host system end 62 is provided with a power-switching device 64 that permits to choose or remove an optimum power source.

The CardBay standards include a new connector-pin assignment system, a new-card judgement mechanism, and a new definition of serial buses. Hence, the CardBay standards are capable of supporting various kinds of data paths 74, including the PC card interface, USB interface, all the way up to USB2.0. The whole system architecture of the new CardBay standards, including several general standards, such as measurements of memory card, electrical ratings, communication protocol, connection ports, and codes, etc., is established already though, some other detailed regulations and standards are still pendent for finalization, which wouldn't be discussed herein.

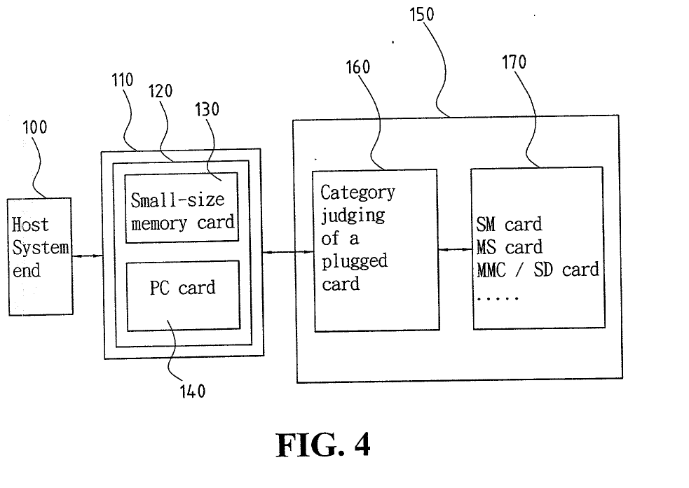

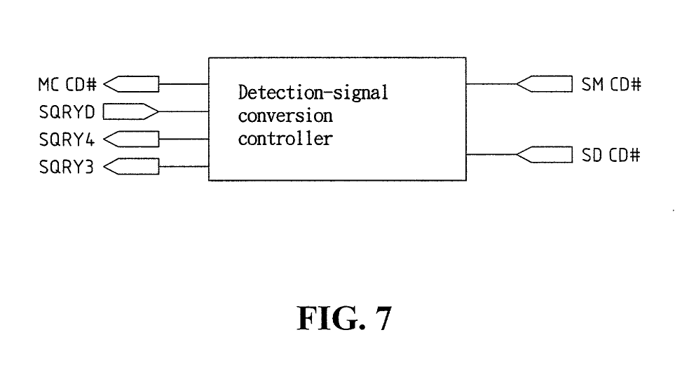

Now, referring to FIG. 4—a block diagram of control flowchart of a portable memory card according to this invention, a memory card adapter 150 or a memory card adapter 150 based on CardBay standards is constructed just about the same with the architecture described in the abovesaid prior art, which won't be reiterated in detail herein. Some circuitry layouts (shown in FIG. 7) are added to joint together with “Category judgement on a plugged card 160” and “Judgement on various small-size memory cards 170”. The memory card adapter 150 might be plugged directly in digital products, such as in the host end 100 of a PDA or NB, or via a bridge unit 110, such as in conversion between PCMCIA interface and PCI/IDE interface for a desktop computer, in which the bridge unit 110 is provided with a first controller 120 of CardBay standards for controlling a PC card 140 (PCMCIA card) and a small-size memory card 130.

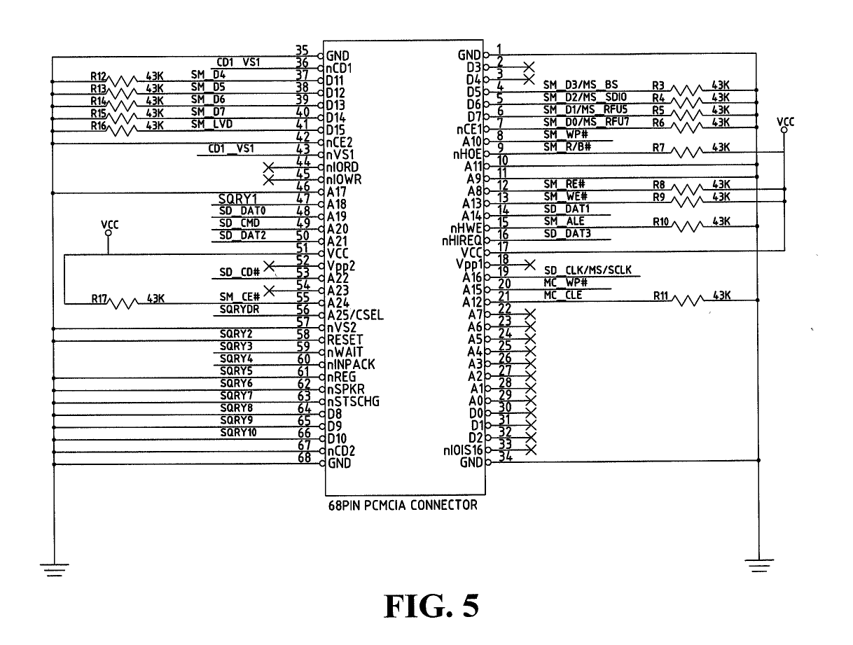

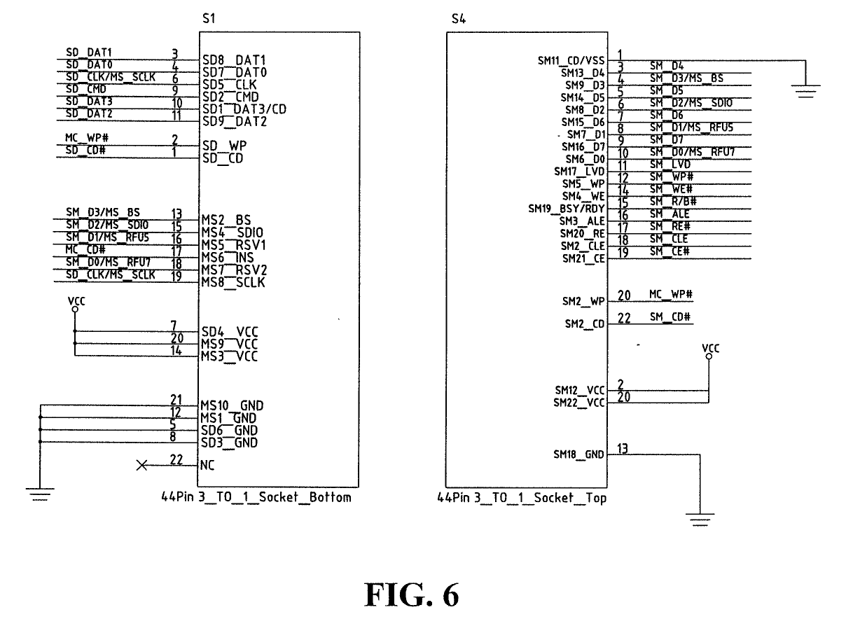

FIG. 5 shows an interface circuit of this invention in connection with a PC card, in which function is assigned and definition is made to every pin of the PC card 200. FIG. 6 shows a circuit for conversion of a small-size memory card 210 of this invention into a PC card with 22 pins.

The memory card adapter of this invention can fit in with three kinds of memory cards on the basis of CardBay standards, namely: the SM card (Smart media card), MMC card (Multimedia card)/SD card (Secure digital card), and MS card (Memory stick card).

Referring to FIG. 7—a block diagram for judging category of a memory card according to this invention, different memory cards inserted in a single memory card adapter in different time might be detected by using a detection-signal conversion controller 220. In FIG. 7, a newly joined memory card is detected when MC_CD# is detected “low(0)”; a SM card is found plugged if SM—CD# is detected “low(0)” while SQRY3 is “high(1)” and SQRY4 is “low(0)”; a MS card is found plugged if both the SQRY 3 and SQRY4 are detected “high(1)”; and MMC/SD card is found plugged if SD_CD#, SQRY3, and SQRY4 are detected “low(0)”, “low(0)”, and “high(1)” respectively.

In summarizing the above, this invention is to propose a passive adapter based on CardBay standards for portable memory cards, in which a chip is transferred and combined to the host system chip or embedded in a bridge chip such that an adapter module of this invention can fit in with various memory cards for reducing cost and raising additive value.

Another object of this invention is to provide a passive adapter for portable memory cards that keeps the USB (Universal serial bus) interface available on the basis of CardBay standards and is applicable to versions of PC card, such as Carbus (the third generation PC card standards) or the 16-bit PC card (the second generation PC card), of portable products (NB and PDA for example). Besides, the CardBay standards also regulate the “Plug and Play” function for combining the memory card adapter intimately with a portable device.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A passive adapter for portable memory cards, in which a bridge unit is inserted in a corresponding PCMCIA card interface; the bridge unit uses a first controller to detect said PCMCIA card interface, which is made in form of a module comprising a slot and a second controller, in which the slot allows to accommodate a plurality of different memory cards on one-at-a-time basis for the controller to detect the category of an inserted memory card; and this invention is characterized in: removing said second controller of the module and adding the functions of the second controller to the first controller of the bridge unit; and using an added detection-signal conversion controller of the module for detection of those memory cards.

2. The passive adapter according to claim 1, in which the bridge unit includes the host system end.
